(19) United States
(12) Patent Application Publication
(10) Pub. No.: US 2006/0105701 A1
(43) Pub. Date: May 18, 2006

(54) Jamming system

(76) Inventor: James Henly Cornwell, Ruther Glen, VA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/989,034

(22) Filed: Nov. 16, 2004

(51) Int. Cl. H04K 3/00

(52) U.S. Cl. 455/1; 455/99

(57) ABSTRACT

A jamming apparatus includes jamming control circuitry and plural antenna sets fed by the jamming control circuitry. A first antenna set includes first and second directional antennas directed along respective first and second main lobe directions that are parallel to one another. A second antenna set includes first and second omni antennas. In a particular example, the first and second directional antennas are mounted on a roof of a motor vehicle near a forward edge and are displaced from one another along a first lateral direction transverse to a longitudinal axis of the motor vehicle. The longitudinal axis is parallel to each of the main lobe directions. The first and second omni antennas are mounted on the roof of the motor vehicle near a rearward edge and are displaced from one another along a second lateral direction transverse to the longitudinal axis.

### BACKGROUND OF THE INVENTION

1. Field of the Invention

The present invention relates to jamming systems, and in particular, the invention relates to vehicle mounted systems that jam electromagnetic signals from remote control devices.

2. Description of Related Art

Wide bandwidth noise jamming devices are known. These jamming devices generally are stationary deployed and focus radiated power in a particular direction. Mines and other ordinance that can be detonated remotely using a radio control link can threaten convoys of motor vehicles. Stationary deployed jamming devices are of little use to protect convoys since the convoys will soon drive beyond the range of the jamming devices. What is needed is a bubble of protection around the jamming vehicle with a lobe of protection ahead of the vehicle to cover other vehicles in the convoy.

### SUMMARY OF THE INVENTION

These needs are met with a jamming apparatus that includes jamming control circuitry and plural antenna sets fed by the jamming control circuitry. A first antenna set includes first and second directional antennas directed along respective first and second main lobe directions that are parallel to one another. A second antenna set includes first and second omni antennas.

### BRIEF DESCRIPTION OF DRAWINGS

The invention will be described in detail in the following description of preferred embodiments with reference to the following figures.

FIG. 1 is a perspective view of a vehicle protected by a jamming apparatus.

FIG. 2 is a plan view of a directional antenna as might be used in jamming apparatus depicted in FIG. 1.

FIG. 3 is a block diagram of jamming control circuitry as might be used in the . . . .

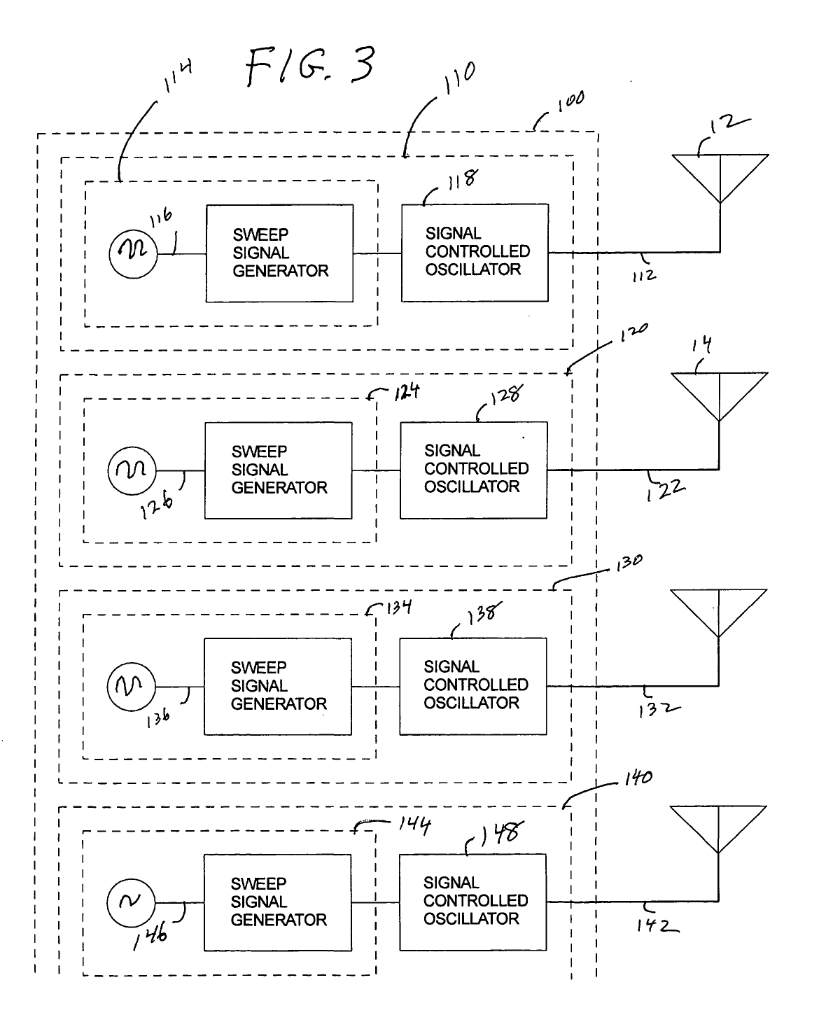

FIG. 4 is a radiation pattern diagram, plan view, of the results of the jamming apparatus depicted in FIG. 1.

### DETAILED DESCRIPTION OF PREFERRED EMBODIMENTS

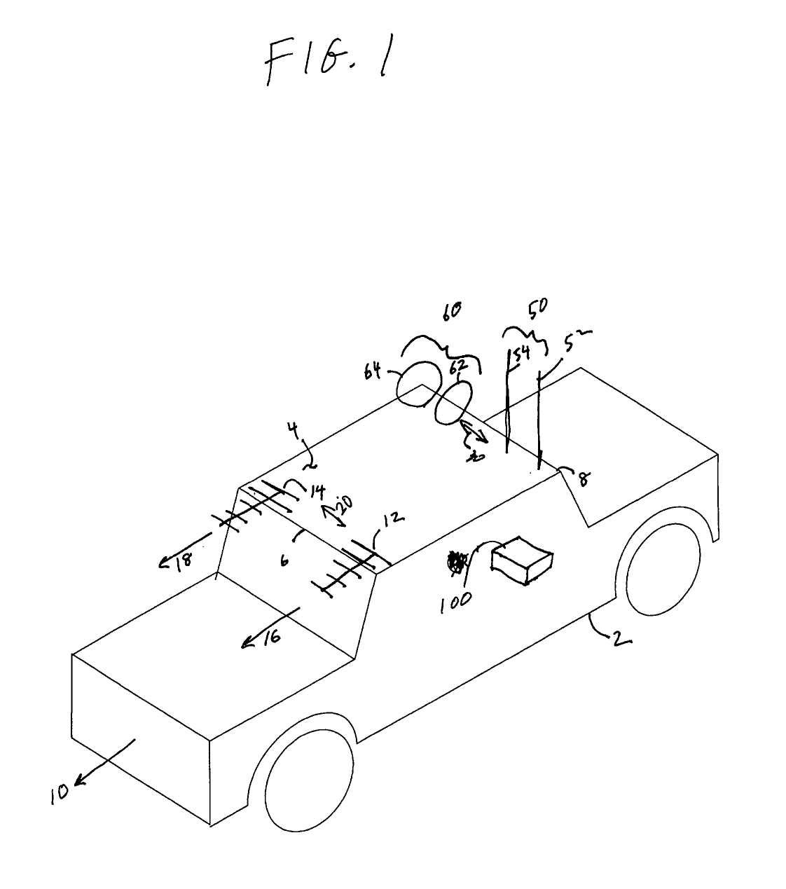

In FIG. 1, a vehicle mounted jamming apparatus is depicted. In FIG. 1, a jamming apparatus is carried on a motor vehicle 2 generally traveling in a longitudinal direction 10. The motor vehicle includes a roof 4 (may be an upper deck, etc.) that has a forward edge 6 and a rearward edge 8. Jamming control circuitry 100 is carried somewhere in the vehicle and connected to the various antennas by cables or other suitable transmission means. The jamming apparatus includes a first antenna set that includes first and second directional antennas 12, 14 directed along respective first and second main lobe directions 16, 18, a second antenna set 50 that includes first and second omni antennas 52, 54, and a third antenna set 60 that includes third and fourth omni antennas 62, 64. The first and second directional antennas 12, 14 are arrayed in a first lateral direction 20 along the forward edge 6 of the roof 4, and the first and second omni antennas 52, 54 and the third and fourth omni antennas 62, 64 are arrayed in a second lateral direction 30 along the rearward edge 8 of the roof 4. Suitable antenna mounts are employed to secure the antennas in the configuration shown.

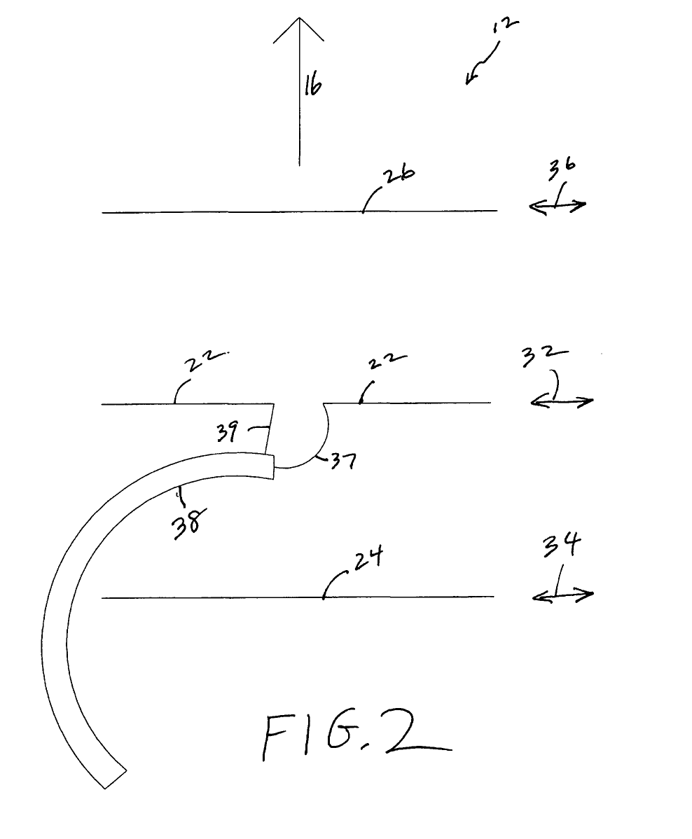

In FIG. 2, basic elements of one type of directional (beam) antenna are depicted. For example, first directional antenna 12 might include a driven antenna element 22, a reflector antenna element 24 and at least one director antenna element 26. Such a construction is sometimes called a Yagi antenna. The driven antenna element 22 is oriented along a driven element direction 32 transverse to one of the first and second main lobe directions 16 or 18. The driven element, by itself, is a center fed half-dipole antenna, fed by feed cable 38 which is typically a coaxial cable. The center conductor of the coaxial cable connects to one half of the half-dipole antenna, and the outer conductor of the coaxial cable connects to the other half of the half-dipole antenna. Other coupling means might be employed such as baluns, transformers, etc. The reflector antenna element 24 is oriented along a reflector element direction 34 parallel to the driven element direction 32. The reflector element functions similar to a ground plane. Each director element of the director antenna elements 26 is oriented along a respective director element direction 36 parallel to the driven element direction 32. The director element function as a resonator that is spatially separated from the driven element. Collectively, the driven antenna element 22, the reflector antenna element 24 and the at least one director antenna element 26 function to shape a main antenna beam directed toward direction 16. Typically, the antenna elements are mounted on a non-conducting boom or are mounted so as to be insulated from the boom. The boom maintains the spacing between elements. The spacing between the several elements of the antenna are calculated from well known principals to ensure a main beam directed toward direction 16.

Referring to FIGS. 1 and 2, in an embodiment of an apparatus according to the invention, a jamming apparatus includes jamming control circuitry 100 and plural antenna sets fed by the jamming control circuitry. A first antenna set includes first and second directional antennas 12, 14 directed along respective first and second main lobe directions 16, 18 that are parallel to one another. The directional antennas may be any form of beam forming antenna that is appropriate for the frequency band being jammed. For example, the antenna might be a Yagi design, a feed horn design, a parabolic reflector design, etc. A second antenna set includes first and second omni antennas, either 52, 54 or 62, 64. These antennas generally provide no specific beam formation. However, as with all real world antennas, they do not produce perfect isotropic radiation patterns. Instead, they generally radiate in all directions around the horizon (360 degrees), but radiation up or down is not critical.

In a first variant of the embodiment of the apparatus, each of the first and second directional antennas 12, 14 include a driven antenna element 22, a reflector antenna element 24 and at least one director antenna element 26 (See FIG. 2). The driven antenna element 22 is oriented along a driven element direction 32 transverse to one of the first and second main lobe directions 16 or 18. The reflector antenna element 24 is oriented along a reflector element direction 34 parallel to the driven element direction 32. Each director element of the at least one director antenna element 26 is oriented along a respective director element direction 36 parallel to the driven element direction 32.

In an example of the first variant of the embodiment of the apparatus, the first and second directional antennas 12, 14 are mounted on a roof 4 of a motor vehicle 2 near a forward edge 6 and are displaced from one another along a first lateral direction 20 transverse to one of the first and second main lobe directions 16, 18. The driven element direction 32 is parallel to the first lateral direction 20.

In a second variant of the embodiment of the apparatus, the jamming apparatus is mounted on a motor vehicle 2 having a longitudinal direction 10 parallel to each of the main lobe directions 16, 18. The first and second directional antennas 12, 14 are mounted on a roof 4 of the motor vehicle 2 near a forward edge 6 and are displaced from one another along a first lateral direction 20 transverse to the longitudinal direction 10. The first and second omni antennas, 52, 54 or 62, 64, are mounted on the roof 4 of the motor vehicle 2 near a rearward edge 8 and are displaced from one another along a second lateral direction 30 transverse to the longitudinal direction 10. In an exemplary configuration, the forward edge 6 and rearward edge 8 are separated by about 8 feet, but this could be more or less depending on the vehicle on which the antennas are mounted.

In an example of the second variant of the embodiment of the apparatus, the first and second omni antennas, 52, 54 or 62, 64, are separated along the second lateral direction 30 by an odd number of quarter wavelengths, the wavelength being determined at a resonant frequency that characterizes the first omni antenna.

In a third variant of the embodiment of the apparatus, the first and second omni antennas 62, 64 are loop antennas. The loop antenna may be any of a circular loop, a square or rectangular loop, a rhombic antenna or a multi-faceted or polygon loop antenna, etc. The first omni antenna 62 is driven by an omni signal from the jamming control circuitry 100. The second omni antenna 64 freely resonates upon being excited by radiation from the first omni antenna 62.

In a first example of the third variant of the embodiment of the apparatus, the first and second directional antennas 12, 14 are mounted on a roof 4 of a motor vehicle 2 near a forward edge 6 and are displaced from one another along a first lateral direction 20 transverse to one of the first and second main lobe directions 16, 18. The first omni antenna 62 lies in a plane that is either substantially perpendicular to a plane of the roof 4, substantially orthogonal to the first lateral direction 20, or both.

In a second example of the third variant of the embodiment of the apparatus, the first omni antenna 62 operates as a resonant antenna at a frequency of the omni signal. In its simplest form, the loop is circumference is limited to an integer multiple of the wavelength of the driving signal; however, the antenna my be inductively loaded, or even capacitively loaded, to alter the geometry requirements for a resonant antenna. Often the loading of antennas are used to achieve impedance match with the feed impedance.

In a first alternative of the second example of the third variant of the embodiment of the apparatus, the first omni antenna 62 is characterized by a perimeter length substantially equal to an integer multiple of a wavelength of the omni signal.

In a second alternative of the second example of the third variant of the embodiment of the apparatus, the first omni antenna 62 is an inductively loaded loop antenna.

In a fourth variant of the embodiment of the apparatus, the first and second omni antennas 52, 54 are whip antennas. Here, by the use of the term whip antenna, the antenna is intended to be what is commonly called a vertical antenna. Vertical antennas at lower frequencies are often needed to efficiently use real estate, and they generate or receive vertically polarized electromagnetic radiation. The term whip is used in the present case since the antenna may be vehicle mounted, and the vehicle may be tilted to one side or the other, or from front to back, as the terrain under the vehicle path varies. The first omni antenna 52 is driven by an omni signal from the jamming control circuitry 100. The second omni antenna 54 freely resonates upon being excited by radiation from the first omni antenna 52.

In a first example of the fourth variant of the embodiment of the apparatus, the first and second directional antennas 12, 14 are mounted on a roof 4 of a motor vehicle 2 near a forward edge 6 and are displaced from one another along a first lateral direction 20 transverse to one of the first and second main lobe directions 16, 18. The first omni antenna 52 extends in a direction substantially orthogonal to a plane of the roof 4. The second omni antenna 54 extends in a direction substantially orthogonal to a plane of the roof 4 and is displaced from the first omni antenna in a direction parallel to the first lateral direction 20.

In a second example of the fourth variant of the embodiment of the apparatus, the first omni antenna 52 operates as a resonant antenna at a frequency of the omni signal. In its simplest form, the length of a whip antenna, operated at a resonant frequency, is one-quarter of a wavelength. However, the radiation pattern may not be as desired, and the length of such an antenna may be varied from one-quarter wavelength to one-half wavelength to adjust the angle of the radiation pattern over the ground.

In a first alternative to the second example of the fourth variant of the embodiment of the apparatus, the first omni antenna 52 is characterized by a ratio of a length of the first omni antenna divided by a wavelength of the omni signal that is in a range between one-quarter and one-half.

In a second alternative to the second example of the fourth variant of the embodiment of the apparatus, the first omni antenna 52 is an inductively loaded whip antenna. Often, short whip antennas are desired. To make the whip antenna physically short but still electrically long (i.e., one-quarter to one-half wavelength), an inductor may be inserted at locations along the length of the whip antenna. Typical locations are at the bottom of the antenna where the feed attaches and in the middle of the whip antenna.

In a third example of the fourth variant of the embodiment of the apparatus, the plural antenna sets further includes a third antenna set 60, and the third antenna set includes third and fourth omni antennas 62, 64. The third and fourth omni antennas are loop antennas. The third omni antenna 62 is driven by another omni signal from the jamming control circuitry 100. The fourth omni antenna 64 freely resonates upon being excited by radiation from the third omni antenna 62.

In a first alternative to the third example of the fourth variant of the embodiment of the apparatus, the first and second directional antennas 12, 14 are mounted on a roof 4 of a motor vehicle 2 near a forward edge 6 and are displaced from one another along a first lateral direction 20 transverse to one of the first and second main lobe directions 16, 18. The third omni antenna 62 lies in a plane that is substantially perpendicular to a plane of the roof 4, substantially orthogonal to the first lateral direction 20, or both.

In a second alternative to the third example of the fourth variant of the embodiment of the apparatus, the third omni antenna 62 operates as a resonant antenna at a frequency of the omni signal.

In a fifth variant of the embodiment of the apparatus, the jamming control circuitry 100 includes a first sweep oscillator 110 and a first feed 112 coupled between the first sweep oscillator and the first directional antenna 12. The jamming control circuitry 100 further includes a second sweep oscillator 120 and a second feed 122 coupled between the second sweep oscillator and the second directional antenna 14. The first and second feeds are characterized by different effective lengths.

In a first example of the fifth variant of the embodiment of the apparatus, the first sweep oscillator 110 includes a first sweep signal generator 114 onto which as been modulated a first noise signal 116. The noise signal may be any form of noise, but is typically white noise (evenly distributed in frequency over a bandwidth). The sweep signal generator may be a signal generator generating a signal in the shape of a sawtooth, in the shape of a sinusoid, in a triangular shape, or in a trapezoid shape. Other sweep waves may also be used. The noise signal is added to the sweep waveform in predefined proportions (e.g., equal proportions) to produce a signal to drive a signal controlled oscillator. The noise signal provides the randomness that is needed and the sweep waveform provides the scanning over the bandwidth that is needed. The first sweep oscillator 110 further includes a first signal controlled oscillator 118 coupled to the first feed 112 and is responsive in frequency to the first sweep signal generator 114. Typically, this is a voltage controlled oscillator. When viewed on a spectrum analyzer, the output of the signal controlled oscillator will be observed to be of varying frequency over a bandwidth in response to the noisy signal from the sweep signal generator. The second sweep oscillator 120 includes a second sweep signal generator 124 onto which as been modulated a second noise signal 126. The second sweep oscillator 120 further includes a second signal controlled oscillator 128 coupled to the second feed 122 and is responsive in frequency to the second sweep signal generator 124.

In a second example of the fifth variant of the embodiment of the apparatus, the first directional antenna 12 produces a first radiation pattern responsive to the first sweep oscillator 110, and the second directional antenna 14 produces a second radiation pattern responsive to the second sweep oscillator 120. The jamming apparatus is mounted on a motor vehicle 2 having a longitudinal direction 10 parallel to each of the main lobe directions 16, 18. The first and second directional antennas 12, 14 are mounted on a roof 4 of the motor vehicle 2 near a forward edge 6 and are displaced from one another along a first lateral direction 20 transverse to the longitudinal direction 10. The first and second radiation patterns combine with one another to produce a distorted radiation pattern. The distorted radiation pattern has a main lobe and plural sidelobes. The main lobe is generally oriented in a direction aligned with the longitudinal direction 10.

In operation, when the random frequencies of the first sweep oscillator 110 are applied to a specific antenna, particularly a directional antenna, randomly directed antenna radiation patterns are produced. The radiation direction and polarization out of the antenna is, at least in part, responsive to the random frequencies provided by the first sweep oscillator 110. The same can be said for the second, third and fourth sweep oscillators 120, 130, 140. Radiation patterns of a specific antenna are dependent on the frequency of the signal provided to the antenna.

In addition, the radiation pattern from a real world antenna is well characterized in only a limited number of directions (e.g., boresight, back lobe, etc.). When one observes the amplitude, phase and polarization of the radiation at other angles, the radiation pattern is not easily calculated. For example, for a directional antenna, a Yagi antenna, mounted high above the ground on roof 4 of vehicle 2 and pointed directly ahead, the amplitude, phase and polarization of radiation from the Yagi antenna at a point, say 36 degrees left of boresight (i.e., parallel to direction 10) and angled down toward the ground near the left tires of vehicle 2, are not easily calculated. A horizontally arranged Yagi antenna pointed dead ahead produces both horizontal and vertical radiation components at the angle described. The phase and amplitude of the antenna beam pattern is equally complex at this angle. Then, when the antenna is driven by a frequency varying signal from the sweep oscillator onto which random noise has been applied, the radiation propagating along any arbitrary angle is truly random. This is from just one antenna.

When multiple antennas, each driven by independent noisy sweep oscillators as described herein, are all operating at the same time, the radiation pattern surrounding the vehicle 2 is truly random over the bandwidth. Furthermore, the first directional antenna 12 produces a first radiation pattern with a main beam only generally directed in direction 16, and the second directional antenna 14 produces a second radiation pattern with a main beam only generally directed in direction 18. These two main beams, together with the like directed radiation for the other antennas, produce a distorted radiation pattern generally extending greater random noise jamming power along direction 10. Such a distorted radiation pattern, that has a main lobe, directed forward enables the jamming apparatus deployed on a vehicle to provide jamming cover over the jamming vehicle and other, unprotected, vehicles in a convoy.

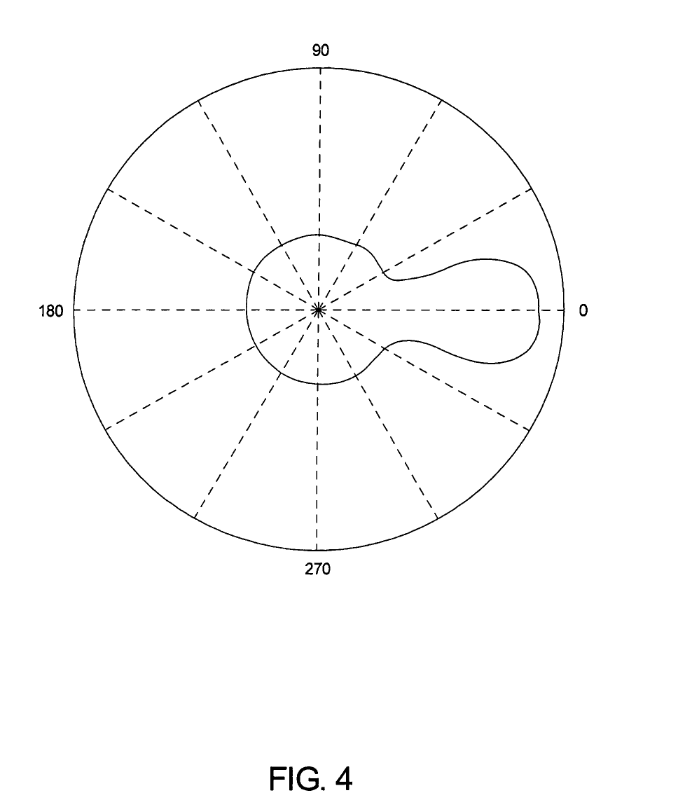

FIG. 4 illustrates a plan view of a radiation power pattern of the type that results from the jamming apparatus discussed above. The directional antennas are oriented to generate primarily horizontal polarized radiation at boresight (0 degrees), the whip antennas are oriented to generate primarily vertical polarized radiation at boresight (0 degrees), and the loop antennas generate both horizontal and vertical polarized radiation. However, as discussed above, projection of the radiation from antennas so oriented at angle other than boresight results in cross polarization where radiation at other angles than boresight (e.g., off to the side of boresight and down a little) will result in a mix of both horizontal and vertical polarized radiation. In FIG. 4, the radiation pattern around the vehicle is largely a 360 degree circle or bubble of protection with a relatively constant power (except near boresight where the power level is greater). This radiation power includes both vertical and horizontal polarization, and the radiation is random in frequency over a desired frequency band. For example, it may be desirable to jam frequencies between 400 MHz and 500 MHz, and therefore, the jamming radiation would spread a noise signal over this frequency band. The radiation in the boresight direction (0 degrees) is largely the result of the directional antennas, and where it projects forward, beyond the bubble of protection, its polarization is largely determined by the polarization of the directional antennas. However, the radiation is still random in frequency over a desired frequency band.

Having described preferred embodiments of a novel jamming system (which are intended to be illustrative and not limiting), it is noted that modifications and variations can be made by persons skilled in the art in light of the above teachings. It is therefore to be understood that changes may be made in the particular embodiments of the invention disclosed which are within the scope of the invention as defined by the appended claims.

Having thus described the invention with the details and particularity required by the patent laws, what is claimed and desired protected by Letters Patent is set forth in the appended claims.

What is claimed is:

1. A jamming apparatus comprising jamming control circuitry and plural antenna sets fed by the jamming control circuitry, wherein:
a first antenna set includes first and second directional antennas directed along respective first and second main lobe directions that are parallel to one another; and
a second antenna set includes first and second omni antennas.

2. A jamming apparatus according to claim 1, wherein each of the first and second directional antennas include:
a driven antenna element oriented along a driven element direction transverse to one of the first and second main lobe directions;
a reflector antenna element oriented along a reflector element direction parallel to the driven element direction; and
at least one director antenna element, each director element being oriented along a respective director element direction parallel to the driven element direction.

3. A jamming apparatus according to claim 2, wherein:
the first and second directional antennas are mounted on a roof of a motor vehicle near a forward edge and are displaced from one another along a first lateral direction transverse to one of the first and second main lobe directions; and
the driven element direction is parallel to the first lateral direction.

4. A jamming apparatus according to claim 1, wherein:
the jamming apparatus is mounted on a motor vehicle having a longitudinal direction parallel to each of the main lobe directions;
the first and second directional antennas are mounted on a roof of the motor vehicle near a forward edge and are displaced from one another along a first lateral direction transverse to the longitudinal direction;
the first and second omni antennas are mounted on the roof of the motor vehicle near a rearward edge and are displaced from one another along a second lateral direction transverse to the longitudinal direction.

5. A jamming apparatus according to claim 4, wherein the first and second omni antennas are separated along the second lateral direction by an odd number of quarter wavelengths, the wavelength being determined at a resonant frequency that characterizes the first omni antenna.

6. A jamming apparatus according to claim 1, wherein:
the first and second omni antennas are loop antennas;
the first omni antenna is driven by an omni signal from the jamming control circuitry; and
the second omni antenna freely resonates upon being excited by radiation from the first omni antenna.

7. A jamming apparatus according to claim 6, wherein:
the first and second directional antennas are mounted on a roof of a motor vehicle near a forward edge and are displaced from one another along a first lateral direction transverse to one of the first and second main lobe directions; and
the first omni antenna lies in a plane that is at least one of substantially perpendicular to a plane of the roof and substantially orthogonal to the first lateral direction.

8. A jamming apparatus according to claim 6, wherein the first omni antenna operates as a resonant antenna at a frequency of the omni signal.

9. A jamming apparatus according to claim 8, wherein the first omni antenna is characterized by a perimeter length substantially equal to an integer multiple of a wavelength of the omni signal.

10. A jamming apparatus according to claim 8, wherein the first omni antenna is an inductively loaded loop antenna.

11. A jamming apparatus according to claim 1, wherein:
the first and second omni antennas are whip antennas;
the first omni antenna is driven by an omni signal from the jamming control circuitry; and
the second omni antenna freely resonates upon being excited by radiation from the first omni antenna.

12. A jamming apparatus according to claim 11, wherein:
the first and second directional antennas are mounted on a roof of a motor vehicle near a forward edge and are displaced from one another along a first lateral direction transverse to one of the first and second main lobe directions;
the first omni antenna extends in a direction substantially orthogonal to a plane of the roof; and
the second omni antenna extends in a direction substantially orthogonal to a plane of the roof and is displaced from the first omni antenna in a direction parallel to the first lateral direction.

13. A jamming apparatus according to claim 11, wherein the first omni antenna operates as a resonant antenna at a frequency of the omni signal.

14. A jamming apparatus according to claim 13, wherein the first omni antenna is characterized by a ratio of a length of the first omni antenna divided by a wavelength of the omni signal that is in a range between one-quarter and one-half.

15. A jamming apparatus according to claim 13, wherein the first omni antenna is an inductively loaded whip antenna.

16. A jamming apparatus according to claim 11, wherein:
the plural antenna sets further includes a third antenna set;
the third antenna set includes third and fourth omni antennas;
the third and fourth omni antennas are loop antennas;
the third omni antenna is driven by another omni signal from the jamming control circuitry; and
the fourth omni antenna freely resonates upon being excited by radiation from the third omni antenna.

17. A jamming apparatus according to claim 16, wherein:
the first and second directional antennas are mounted on a roof of a motor vehicle near a forward edge and are displaced from one another along a first lateral direction transverse to one of the first and second main lobe directions; and
the third omni antenna lies in a plane that is at least one of substantially perpendicular to a plane of the roof and substantially orthogonal to the first lateral direction.

18. A jamming apparatus according to claim 16, wherein the third omni antenna operates as a resonant antenna at a frequency of the omni signal.

19. A jamming apparatus according to claim 1, wherein:
the jamming control circuitry includes a first sweep oscillator and a first feed coupled between the first sweep oscillator and the first directional antenna;
the jamming control circuitry further includes a second sweep oscillator and a second feed coupled between the second sweep oscillator and the second directional antenna; and
the first and second feeds are characterized by different effective lengths.

20. A jamming apparatus according to claim 19, wherein:
the first sweep oscillator includes a first sweep signal generator onto which as been modulated a first noise signal;
the first sweep oscillator further includes a first signal controlled oscillator coupled to the first feed and is responsive in frequency to the first sweep signal generator;
the second sweep oscillator includes a second sweep signal generator onto which as been modulated a second noise signal; and
the second sweep oscillator further includes a second signal controlled oscillator coupled to the second feed and is responsive in frequency to the second sweep signal generator.

21. A jamming apparatus according to claim 19, wherein:
the first directional antenna produces a first radiation pattern responsive to the first sweep oscillator;
the second directional antenna produces a second radiation pattern responsive to the second sweep oscillator;
the jamming apparatus is mounted on a motor vehicle having a longitudinal direction parallel to each of the main lobe directions;
the first and second directional antennas are mounted on a roof of the motor vehicle near a forward edge and are displaced from one another along a first lateral direction transverse to the longitudinal direction; and
the first and second radiation patterns combine with one another to produce a distorted radiation pattern, the distorted radiation pattern having a main lobe and plural sidelobes, the main lobe being generally oriented in a direction aligned with the longitudinal direction.
